(19) United States
(12) Patent Application Publication
(10) Pub. No.: US 2025/0373340 A1
(43) Pub. Date: Dec. 4, 2025

(54) SYSTEM FOR QUANTUM INFORMATION RETRIEVAL

(71) Applicants: MELLANOX TECHNOLOGIES, LTD., Yokneam (IL); BAR-ILAN UNIVERSITY, Ramat Gan (IL)

(72) Inventors: Ziv ABELSON, Even Yehuda (IL); Elad MENTOVICH, Tel Aviv (IL); Ran HASSON RUSO, Pardes Hanna-Karkur (IL); Eliahu COHEN, Rehovot (IL); Yuval IDAN, Rishon LeZion (IL); Avshalom C. ELITZUR, Zavdiel (IL); Ariel ASHKENAZY, Rosh HaAyin (IL); Tal GOFMAN, Haifa (IL)

(73) Assignees: MELLANOX TECHNOLOGIES, LTD., Yokneam (IL); BAR-ILAN UNIVERSITY, Ramat Gan (IL)

(21) Appl. No.: 18/731,918

(22) Filed: Jun. 3, 2024

(51) Int. Cl. H04B 10/70; G01J 1/44; H04B 10/077; H04B 10/85

(52) U.S. Cl. CPC H04B 10/70; G01J 1/44; H04B 10/0775; H04B 10/85

(57) ABSTRACT

Systems and methods are described for quantum information retrieval. An example system may include a quantum cloning unit, a photon number splitting (PNS) unit, and a variable-strength measurement unit to enhance the accuracy and reliability of quantum state estimations without introducing substantial decoherence. The quantum cloning unit may be used to generate approximate clones of a qubit. If the information is encoded in a multi-photon state resulting in a multi-photon state qubit, then the photon number splitting (PNS) unit may be used to intercept the multi-photon state and reflect a single photon from the multi-photon state, which may then be subjected to quantum cloning. These qubits and qubit clones may then be subjected to variable-strength measurements, which provides detailed analysis with minor disturbance to quantum properties such as superposition and entanglement.

### TECHNOLOGICAL FIELD

Example embodiments of the present invention relate to quantum information retrieval.

### BACKGROUND

In the field of quantum information science, the accurate measurement and manipulation of quantum states is fundamental for the development of effective quantum communication systems. Traditional quantum measurement techniques often disrupt the quantum state due to the quantum measurement problem, where the act of measuring a quantum system can alter the state being measured. This presents a challenge in quantum computing and communication, where preserving the integrity of quantum states is essential for reliable information transfer and processing.

Applicant has identified a number of deficiencies and problems associated with quantum information retrieval. Many of these identified problems have been solved by developing solutions that are included in embodiments of the present disclosure, many examples of which are described in detail herein.

### BRIEF SUMMARY

Systems and methods are therefore provided for quantum information retrieval.

In one aspect, a system for quantum information retrieval is presented. The system comprising: a quantum cloning unit operatively coupled to a quantum communication channel and configured to: receive, via the quantum communication channel, a qubit, wherein the qubit is associated with a quantum state; generate a qubit clone, wherein the qubit clone is associated with a quantum state that is substantially similar to the quantum state of the qubit; and a variable-strength measurement unit operatively coupled to the quantum cloning unit and configured to: measure the quantum state of the qubit clone; and determine the quantum state of the qubit based on the measurement of the quantum state of the qubit clone.

In some embodiments, the variable-strength measurement unit is configured to: measure the quantum state of the qubit; and determine the quantum state of the qubit based on the measurement of the quantum state of the qubit clone and the measurement of the quantum state of the qubit.

In some embodiments, the system further comprises: a photon number splitting (PNS) unit operatively coupled to the quantum communication channel and configured to: determine that the qubit is a multi-photon state qubit; reflect a single photon from the multi-photon state qubit to a secondary quantum unit; and allow transmission of the remaining photons from the multi-photon state qubit to the quantum receiver.

In some embodiments, the PNS unit is configured to: store the single photon in a quantum memory associated with the secondary quantum unit.

In some embodiments, the variable-strength measurement unit is operatively coupled to the PNS unit, and wherein the variable-strength measurement unit is configured to: measure a quantum state of the single photon; and determine the quantum state of the qubit based on the quantum state of the single photon.

In some embodiments, the PNS unit is a single photon Raman interaction (SPRINT) unit, configured to: detect, in a first energy state, an incidence of the multi-photon state qubit, wherein the incidence of the multi-photon state qubit triggers a change in energy state from the first energy state to a second energy state resulting in a reflection of the single photon; and allow, in the second energy state, transmission of the remaining photons from the multi-photon state qubit to the quantum receiver.

In some embodiments, the quantum cloning unit is configured to generate the qubit clone using a controlled-NOT (CNOT) gate, wherein the quantum cloning unit is further configured to: receive the qubit; initialize a secondary qubit, wherein the secondary qubit is associated with an initial quantum state; implement the CNOT gate on the qubit and the secondary qubit; and entangle, using the CNOT gate, the qubit and the secondary qubit to replace the initial quantum state of the secondary qubit with the quantum state of the qubit to generate the qubit clone.

In some embodiments, the quantum cloning unit is configured to: receive a probability ϵ indicating a required similarity between the qubit and the qubit clone; and generate the qubit clone using the following equation: ρ′=ϵ·CNOT·ρ·CNOT+(1−ϵ)·ρ, wherein ρ′ indicates the quantum state of the qubit clone, and wherein ρ indicates the quantum state of the qubit.

In some embodiments, the quantum cloning unit is configured to generate the qubit clone using a SWAP gate, and wherein the quantum cloning unit is further configured to: initialize a target qubit, wherein the target qubit is associated with an initial quantum state; execute an identity operation on the qubit to maintain coherence of the quantum state of the qubit, wherein the identity operation is associated with a probability, p; and implement, using the SWAP gate, a SWAP operation between the qubit and the target qubit to transfer a portion of the quantum state of the qubit to the target qubit to generate the qubit clone, wherein the SWAP operation is associated with a probability, (1−p).

In some embodiments, the quantum cloning unit is configured to: receive a weight associated with the transfer of the portion of the quantum state; and determine the portion of the quantum state to be transferred from the qubit to the target qubit based on at least the received weight.

In another aspect, a system for quantum information retrieval, the system comprising: a photon number splitting (PNS) unit operatively coupled to a quantum communication channel and configured to: detect a multi-photon state qubit, wherein the multi-photon state qubit is associated with a quantum state; reflect a single photon from the multi-photon state qubit to a secondary quantum unit; and allow transmission of the remaining photons from the multi-photon state qubit to the quantum receiver; and a variable-strength measurement unit operatively coupled to the PNS unit and configured to: measure a quantum state of the single photon; and determine the quantum state of the qubit based on the quantum state of the single photon.

In yet another aspect, a method for quantum information retrieval is presented. The method comprising: receiving, at a quantum cloning unit via a quantum communication channel, a qubit, wherein the qubit is associated with a quantum state; generating, using the quantum cloning unit, a qubit clone, wherein the qubit clone is associated with a quantum state that is substantially similar to the quantum state of the qubit; and measuring using a variable-strength measurement unit, the quantum state of the qubit clone; and determining, using the variable-strength measurement unit, the quantum state of the qubit based on the quantum state of the qubit clone.

In yet another aspect, a method for quantum information retrieval is presented. The method comprises: detecting, using a photon number splitting (PNS) unit, a multi-photon state qubit, wherein the multi-photon state qubit is associated with a quantum state; reflecting a single photon from the multi-photon state qubit to a secondary quantum unit; and allowing transmission of the remaining photons from the multi-photon state qubit to the quantum receiver; and measuring, using a variable-strength measurement unit, a quantum state of the single photon; and determining, using the variable-strength measurement unit, the quantum state of the qubit based on the quantum state of the single photon.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1-4 illustrate an example system environment for quantum information retrieval, in accordance with an embodiment of the present invention;

FIG. 5 illustrates an example method for quantum information retrieval using quantum cloning and variable-strength measurement, in accordance with an embodiment of the invention; and

FIG. 6 illustrates an example method for quantum cloning using CNOT gate, in accordance with an embodiment of the invention;

FIG. 7 illustrates an example method for quantum cloning using SWAP gate, in accordance with an embodiment of the invention; and

FIG. 8 illustrates an example method for quantum information retrieval using photon number splitting and variable-strength measurement, in accordance with an embodiment of the invention.

### DETAILED DESCRIPTION

### Overview

Embodiments of the invention implement quantum cloning prior to variable-strength measurement to generate a larger dataset of similar states, which, when subjected to variable-strength measurements (e.g., weak measurement, projective measurement, or any other positive operator-valued measurement (POVM)), can improve the statistical reliability and precision of the measurement outcomes while imparting only a small backaction on the measured quantum state. The process of quantum cloning before variable-strength measurements allows for quantum states to be preserved and analyzed more effectively, especially when some prior knowledge about the quantum states is available. Even though the clones may not be perfect, the quantum cloning process may allow for retention of additional information about the original state, thus enabling a detailed analysis without a significant loss of quantum properties such as superposition and entanglement. As such, the improved precision and reliability of variable-strength measurements, when combined with quantum cloning, facilitate more accurate quantum state estimation. The quantum cloning techniques used may include the probabilistic application of quantum gates such as the Controlled-NOT (CNOT) gate and the SWAP gate capable of generating approximate clones (with limited fidelity) that still share certain characteristics with the original quantum state (e.g., the quantum state of the qubit).

Furthermore, embodiments of the invention contemplate the use of photon number splitting (PNS) using a single photon Raman interaction (SPRINT) unit to intercept quantum communication from quantum transmitters that do not use single-photon sources (e.g., weak coherent states). When a multi-photon pulse is emitted, one or more photons from the pulse can be intercepted without significantly altering the state of the remaining photon(s), and without alerting the quantum transmitter or the intended quantum receiver. The extracted photon(s) may then be measured for information extraction. In an example embodiment, the SPRINT unit may be operatively coupled to the quantum communication channel, with a reflection arm being oriented toward a secondary quantum unit, and the transmission arm being oriented toward the intended quantum receiver. The SPRINT unit (e.g., a single rubidium atom inside a single-sided cavity) is initialized in a first energy (e.g., ground energy) state. When a multi-photon state is detected, the SPRINT unit transitions from the first energy state to a second energy state resulting in a reflection of the single photon. In the second energy state, the SPRINT unit allows the remaining photons in the multi-photon state to be transmitted to the quantum receiver. This transmission can be also reversed such that the quantum receiver obtains only a single photon, and the rest of the photons are retained for further measurements. Embodiments of the invention may then use variable-strength measurements to measure the quantum state of the reflected photon (or the transmitted photons) to gather additional information. In addition, the reflected photon may further be cloned to improve the precision and reliability of variable-strength measurements.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, a “qubit” may refer to the basic unit of quantum information, characterized by its ability to exist simultaneously in multiple states through quantum superposition. Unlike classical bits, which are binary and must be either 0 or 1, a qubit can be both 0 and 1 at the same time, represented mathematically as α|0 [symbol] +β|1 [symbol] , where α and β are complex numbers that describe the probability amplitudes of the qubit's states. Furthermore, the term “qubit” can encompass higher-dimensional quantum systems known as “qudits,” where each unit can exist in more than two states.

It is to be understood that that while the term “qubit” is frequently used throughout this specification for illustrative purposes, the invention is fundamentally focused on the measurement and manipulation of quantum states, which are not necessarily limited to qubits or qudits. The principles and methods described herein apply broadly to quantum states in various forms.

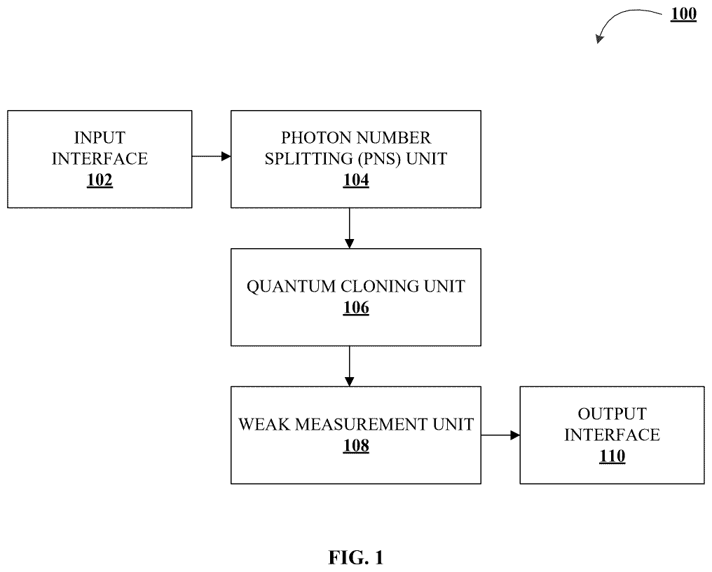

As used herein, the term “unit,” described in some cases using functional language, may include particular hardware configured to perform the functions associated with the respective units as described herein. It should also be understood that certain of these components (e.g., elements 104-108 shown in FIG. 1, and associated components) may include similar or common hardware. While the term “unit” should be understood broadly to include hardware, in some embodiments, the term “unit” may also include software for configuring the hardware. For example, in some embodiments, a “unit” may include processing circuitry, storage media, network interfaces, input/output devices, and the like.

As used herein, “determining” may encompass a variety of actions. For example, “determining” may include estimating, calculating, computing, processing, deriving, investigating, ascertaining, inferring, gathering, and/or the like. Furthermore, “determining” may also include receiving (e.g., receiving information), accessing (e.g., accessing data in a memory), and/or the like. Also, “determining” may include resolving, selecting, choosing, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example System Environment

FIGS. 1-4 illustrate an example system environment 100 for quantum information retrieval, in accordance with an embodiment of the present invention. As shown in FIG. 1, the system environment 100 may include an input interface 102, a PNS unit 104, a quantum cloning unit 106, a variable-strength measurement unit 108, and an output interface 110. FIG. 1 illustrates only one example of an embodiment of the system environment 100, and it will be appreciated that in other embodiments one or more of the systems, units, devices, and/or servers (e.g., quantum transmitter) may be combined into a single system, unit, device, or server. Alternatively, any single component might be divided and functionally distributed across multiple systems, devices, or servers.

The input interface 102 may serve as the primary gateway for receiving qubits. The input interface 102 may be operatively coupled to external devices, such as a quantum transmitter (not shown), through a quantum communication channel (not shown). The input interface 102 may be compatible with various types of quantum transmitters, accommodating different quantum state generation technologies, whether they are based on photonics, spin-qubits, superconducting qubits, or other emerging quantum systems. The input interface 102 may be configured to preserve the coherence and entanglement of the incoming qubits, ensuring that the quantum information is not degraded during the initial reception process.

The quantum communication channel may be a communication medium through which qubits are transmitted from a sender (e.g., quantum transmitter) to a receiver (e.g., quantum receiver). Unlike classical communication channels that transmit bits of information, the quantum communication channel may be configured to preserve and transmit the quantum states of particles, such as photons, over distances without significant loss of information due to decoherence or other quantum noise. The quantum communication channel may be implemented in various mediums based on the application and distance over which communication is required. For example, for terrestrial quantum communication, optical fibers may be used as a medium. The quantum communication channel may use the principles of quantum mechanics, such as the no-cloning theorem and the observation effect (quantum measurements disturb the quantum state), to detect any attempt at cavesdropping during qubit transit.

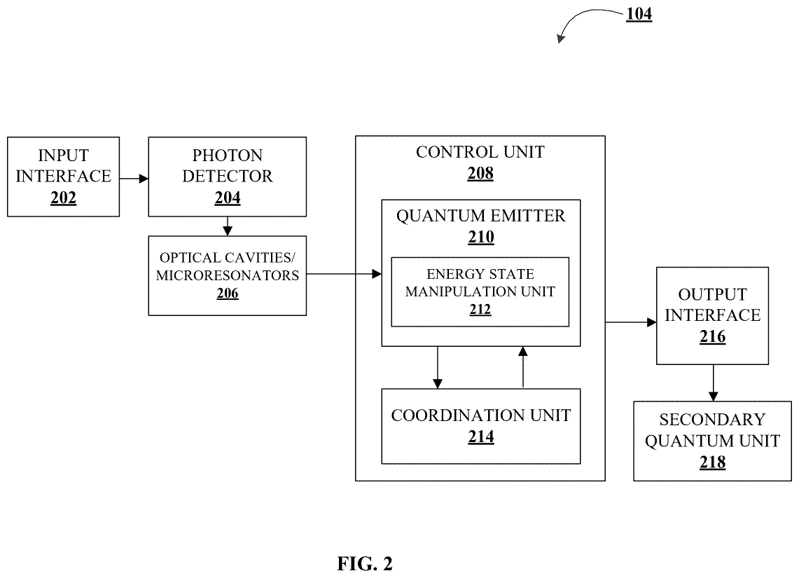

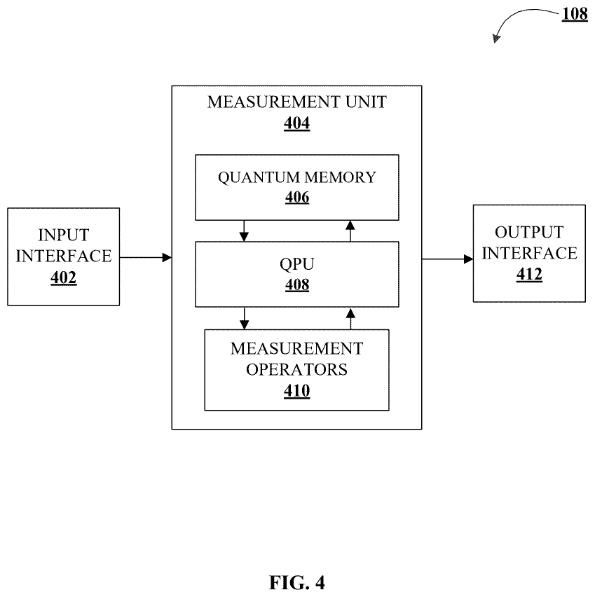

A PNS unit 104 may be operatively coupled to the input interface 102 and configured to address and exploit specific vulnerabilities associated with the use of weak coherent pulses. These pulses, commonly employed in many quantum key distribution (QKD) systems, inherently include the risk of containing multiple photons per pulse due to the statistical nature of their generation. The PNS unit 104 may be configured to identify qubits containing more than one photon. Once a multi-photon pulse is detected, the PNS unit 104 may split one or more photons from the qubit while ensuring that the remaining photons continue on their path with minimal disturbance, thus avoiding detection by the system's legitimate users (as described in more detail in connection with FIG. 4). The intercepted photons may be temporarily stored within the PNS unit 104 in a quantum state-preserving manner, allowing for delayed measurement of the quantum states of these photons. In an example embodiment, the PNS unit 104 may be implemented using a single photon Raman interaction (SPRINT) unit (as described in more detail in connection with FIG. 2).

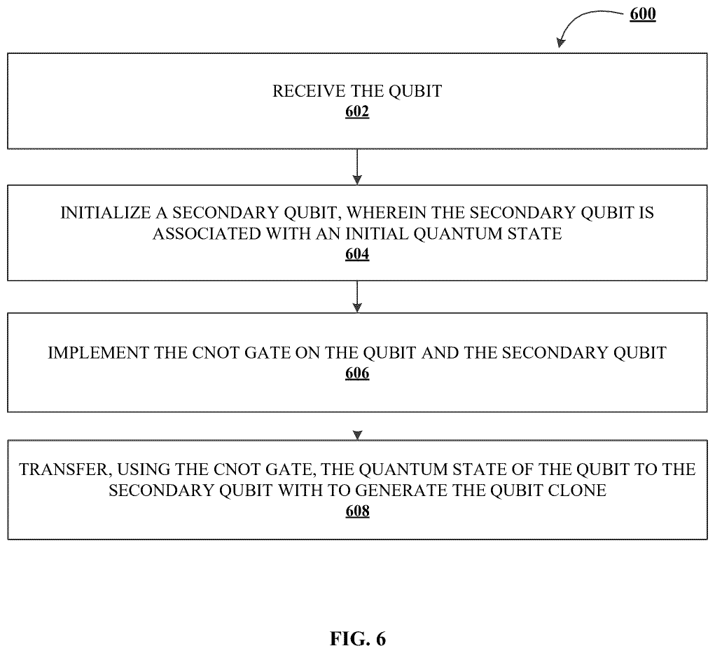

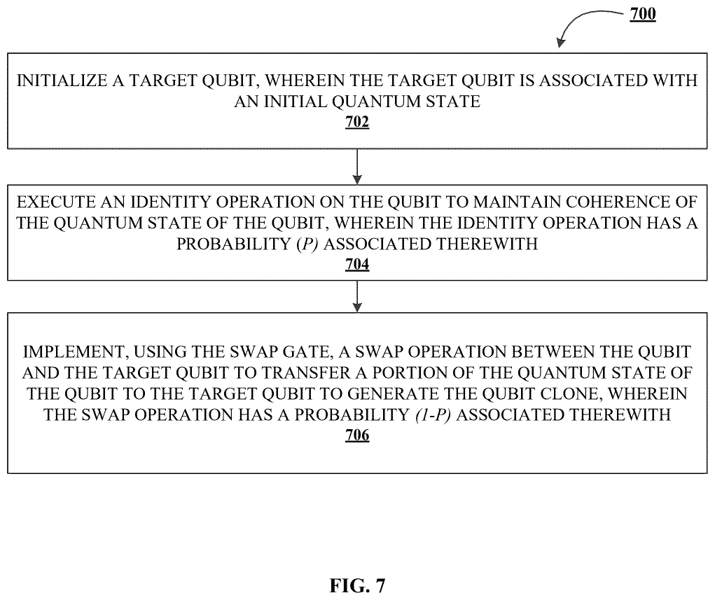

A quantum cloning unit 106 may be operatively coupled to the PNS unit 104 and configured to replicate the quantum states of qubits while adhering to the fundamental principles of quantum mechanics. While the no-cloning theorem prohibits the creation of an identical copy of an arbitrary unknown quantum state, quantum mechanics permits the creation of approximate and/or probabilistic clones. Approximate cloning captures the essential aspects of the quantum state, such as superposition and probabilities, with some degree of inaccuracy inherent in the process. This method is particularly useful when exact replication of the state is not feasible, but a high degree of similarity is desirable. Probabilistic cloning aims to achieve higher fidelity in the clones but only succeeds probabilistically. This method involves scenarios where the cloning process might fail to produce a viable clone on some attempts, but when successful, the clone exhibits a very high resemblance to the original quantum state. As such, in example embodiments described herein, the quantum cloning 106 unit may utilize a controlled-NOT (CNOT) gate for approximate cloning and a SWAP gate for probabilistic cloning. The CNOT and SWAP gates may be employed to manipulate the quantum states of the qubits in a controlled manner to produce the qubit clone (described in more detail in connection with FIGS. 6 and 7). The quantum cloning unit 106 may be configured to toggle between approximate and probabilistic cloning methods depending on the requirements of the specific operation or experiment. Alternatively, both CNOT and SWAP gates may be implemented for probabilistic cloning.

A variable-strength measurement unit 108 may be operatively coupled to the quantum cloning unit 106 and configured to measure quantum states in a way that minimally disturbs the system being observed. Unlike traditional quantum measurements that strongly interact with and often “collapse” the quantum state (fully reducing it to one of the eigen states), variable-strength measurements make only a slight interaction with the quantum state. This approach allows for gathering information from a quantum system without causing a significant decoherence of the system's wavefunction. In specific embodiments, the variable-strength measurement unit 108 may be configured for variable-strength quantum measurement, whereby the strength of the measurement may be adjustable. This allows for flexibility to control the amount of information extracted and the level of disturbance induced in the quantum state. By making repeated variable-strength measurements and varying the measurement parameters, the variable-strength measurement unit 108 may be configured to assess the quantum state of the qubit without overly disturbing it.

The output interface 110 may be operatively coupled to the variable-strength measurement unit 108 and configured to serve as the conduit through which measured outcomes of quantum states are communicated to external systems or devices with high fidelity and precision.

The integration of the PNS unit 104, the quantum cloning unit 106, and the variable-strength measurement unit 108 may enhance quantum information retrieval, providing a robust system for capturing and analyzing quantum states with high fidelity and minimal disturbance. As described herein, the PNS unit 104 may be configured to identify and manipulate quantum states that are part of multi-photon state qubits. Specifically, the PNS unit 104 may selectively reflect a single photon from a multi-photon state qubit while allowing the remaining photons to continue to their intended destination. Once a single photon is isolated by the PNS unit 104, it can be directed to the quantum cloning unit 106. Here, the quantum cloning unit 106 may clone the quantum state of the single photon, producing one or more qubit clones. These qubit clones may not be perfect replicas due to the fundamental limitations imposed by the no-cloning theorem but are close approximations of the quantum state of the original qubit. The original qubit and its associated qubit clones may then be measured by the variable-strength measurement unit 108. The variable-strength measurement unit 108 may be configured for variable-strength quantum measurement, allowing for the adjustment of measurement intensity to minimize the disturbance to the quantum state. By measuring both the original qubit and the qubit clones, the variable-strength measurement unit 108 can gather comprehensive data about the quantum state without causing significant collapse of the quantum state. By combining measurements from the original and cloned qubits, the system can leverage the redundancy and correlations between these measurements to refine the accuracy of the quantum state estimation and information retrieval.

The structure of the system environment 100, as described herein, which facilitates quantum information retrieval, is presented for illustrative purposes only and should not be construed as limiting the scope of the embodiments described and/or claimed in this document. It is emphasized that the specific configuration of the system environment 100, including its constituent components, the interconnections between those components, and the functional dynamics, serves merely as an example instance of how quantum information retrieval can be implemented within such contexts. Variations in the design and operational framework of the system environment 100 are contemplated. For instance, in one embodiment, the system environment 100 might encompass a greater or smaller number of components, or components differing from those detailed herein. Furthermore, in alternative embodiments, the structural composition of the system environment 100 may undergo modification, whereby portions thereof might be integrated into a unified module, or conversely, the entirety of the system environment 100 may be disaggregated into multiple distinct modules. Such modifications and reconfigurations are envisioned to fall within the purview of the embodiments, underpinning the adaptable nature of system environment 100 in addressing the nuances of quantum information retrieval.

### Example PNS Unit

FIG. 2 illustrates an example PNS unit 104, in accordance with an embodiment of the invention. The PNS unit 104 may be a single photon Raman interaction (SPRINT) unit. The SPRINT unit, as described herein, serves as an exemplary implementation of a PNS unit 104. The SPRINT unit is utilized to demonstrate the practical application of PNS methodologies within quantum communication systems (e.g., system environment 100). The SPRINT unit is specified as one example of technology capable of executing PNS functions, particularly through the manipulation and control of photon states within a quantum system. It is important to recognize that other similar devices or systems may also be configured to achieve similar outcomes by employing equivalent or alternative technological means and methods for intercepting, manipulating, and analyzing quantum states. The use of the SPRINT unit in this context is intended to illustrate the broader concept of PNS and is not intended to limit the scope of technologies that can be applied to perform these functions. Other units employing different mechanisms that adhere to the underlying principles of PNS are also contemplated and fall within the scope of this invention.

As shown in FIG. 2, the PNS unit 104 may include an input interface 202, one or more photon detectors 204, one or more optical cavities/microresonators 206, a control unit 208, an output interface 216, and a secondary quantum unit 218. The control unit 208 may include a quantum emitter 210 and a coordination unit 214. The quantum emitter 210 may further include an energy state manipulation unit 212.

The input interface 202 may be the same or similar in configuration to the input interface 102 (shown in FIG. 1). Specifically, the input interface 202 may be operatively coupled to external devices, such as a quantum transmitter (not shown), through a quantum communication channel (not shown). In an example embodiment, the input interface 202 may be operatively coupled to the input interface 102. In another example embodiment, the input interface 202 and the input interface 102 may be the same component.

The photon detector 204 may be operatively coupled to the input interface 202 and configured to identify and quantify the photon state that are received via the input interface 202. As such, the photon detector 204 may be configured to distinguish between single and multiple photon states based on the intensity of the light detected, where higher intensities may indicate multiple photon states. In specific embodiments, the photon detector 204 may provide information associated with the quantum state of the multi-photon qubit, such as the phase, polarization, and other quantum properties.

The optical cavities/microresonators 206 may be operatively coupled to the photon detector 204 and configured to confine light within a very small volume. This confinement may increase the interaction time between the photons of the multi-photon state qubit and the quantum emitter 210 (as described in more detail herein). By confining the photons close to the quantum emitter 210, the probability of effective interaction between the photon detector 204 and the quantum emitter 210 may be significantly increased. In specific embodiments, the optical cavities/microresonators 206 not only hold the photons in proximity to the quantum emitter 210 but also control their paths as they exit the cavity.

The quantum emitter 208 may be operatively coupled to the optical cavities/microresonators 206 and configured to manipulate and control photon states for photon number splitting. The energy state manipulation unit 212 within the quantum emitter 210 may be configured to prepare the quantum emitter 210 in a specific initial energy state based on the desired interaction outcomes with incoming photons. The energy state manipulation unit 212 may be configured to dynamically adjust the energy states of the quantum emitter 210 during operations by responding to variations in the photon characteristics or changes in operational requirements. When photons from the optical cavities/microresonators 206 reach the quantum emitter 210, they are absorbed, causing an electron within the quantum emitter 210 to transition to a higher energy state. Here, the energy state manipulation unit 212 may be configured to ensure that the energy absorbed matches the requirements for effective photon re-emission. Following absorption, the quantum emitter 210, in combination with the energy state manipulation unit 212, may re-emit photons in a process known as Raman scattering. The direction and energy of the emitted photons may be controlled to ensure that they are directed toward specific components of the PNS unit 104 for further processing.

The coordination unit 214 may be operatively coupled to the quantum emitter 210 and configured to adjust the timing and sequence of emissions and transitions of the quantum emitter 210 within the control unit 208. In this regard, the coordination unit 214 may determine the sequence of operations from photon detection to photon manipulation.

The secondary quantum unit 218 may be operatively coupled to the control unit 208 and configured to handle and process photons that have been specifically manipulated, such as those reflected or split from a multi-photon state qubit. In specific embodiments, the secondary quantum unit 218 may include or be associated with a quantum memory that may be configured to store the reflected photon for further processing. In this regard, the quantum memory may be configured to preserve the quantum state of the reflected photon, maintaining the integrity and coherence of the quantum information it carries. Besides storage, the secondary quantum unit 218 may be configured to perform various operations on the stored photons, including further quantum state analysis or state manipulation.

The output interface 216 may be the same or similar in configuration to the output interface 110 (shown in FIG. 1). Specifically, the output interface 216 may be operatively coupled to the control unit 208 and configured to direct the remaining photons—those not reflected or manipulated for further internal processing—toward their intended destination (e.g., the quantum receiver).

The structure of PNS unit 104, as described herein, is presented for illustrative purposes only and should not be construed as limiting the scope of the embodiments described and/or claimed in this document. It is emphasized that the specific configuration of the PNS unit 104, including its constituent components, the interconnections between those components, and the functional dynamics, serves merely as an example instance of how photon number splitting can be implemented within such contexts. Variations in the design and operational framework of the PNS unit 104, including the SPRINT unit configuration, are contemplated. Furthermore, in alternative embodiments, the structural composition of the PNS unit 104 may undergo modification, whereby portions thereof might be integrated into a unified module, or conversely, the entirety of the PNS unit 104 may be disaggregated into multiple distinct modules. Such modifications and reconfigurations are envisioned to fall within the purview of the embodiments.

### Example Quantum Cloning Unit

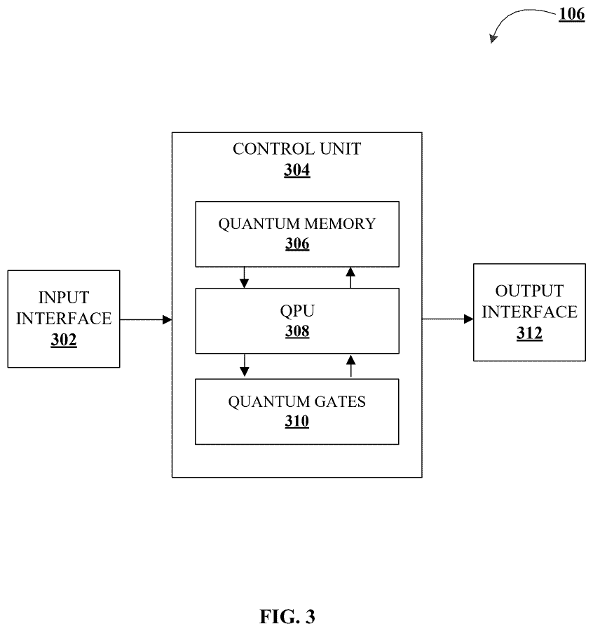

FIG. 3 illustrates an example quantum cloning unit 106, in accordance with an embodiment of the invention. As shown in FIG. 2, the quantum cloning unit 106 (shown in FIG. 1) may include an input interface 302, a control unit 304, and an output interface 312. The control unit 304 may include quantum memory 306, a quantum processing unit (QPU) 308, and quantum gates 310.

The input interface 302 may be the same or similar in configuration to the input interface 102 (shown in FIG. 1) and/or the input interface 202 (shown in FIG. 2). Specifically, the input interface 302 may serve as the initial point of entry for qubits into the quantum cloning unit 106. In an example embodiment, the input interface 302 may be operatively coupled to the secondary quantum unit 218 (as shown in FIG. 2) to receive the reflected photon therefrom.

The control unit 304 may be operatively coupled to the input interface 302 and configured to implement the quantum cloning process. As shown in FIG. 3, the control unit 304 may include a quantum memory 306, a QPU 308, and quantum gates 310. Quantum memory 306 may refer to a device or system that is capable of storing quantum information, which may be represented by quantum states, for a period of time. The quantum memory 306 may be composed of an array of quantum states, each potentially in a superposed configuration. The quantum memory 306 may be responsible for preserving the integrity of quantum states during computation and between operations. In this regard, the quantum memory 306 may employ quantum registers to record the state information of a control unit 304. In complex quantum systems, the quantum memory 306 can synchronize operations by holding quantum states until they are needed, ensuring that different parts of the system can operate in harmony. For example, in the quantum cloning unit 106, the quantum memory 306 may act as a buffer that stores the quantum states of incoming qubits received via the input interface 302.

The QPU 308 may refer to a core computational engine that is configured to perform computational tasks required for cloning the incoming qubit. This may include the execution of algorithms and protocols that dictate how quantum states are manipulated and cloned within the unit. Specifically, the QPU 308 may be configured to direct the operations of quantum gates 310 (e.g., CNOT gate, SWAP gate), configuring them to perform quantum operations that facilitate the cloning process. These quantum gates 310 may be active elements that physically manipulate the quantum states of the qubits. In some embodiments, the QPU 306 may generate and manipulate entangled states, a fundamental quantum resource. As described herein, the quantum gates 310 may be configured to implement the cloning protocols, whether they are aimed at producing approximate clones (e.g., using CNOT gate) or probabilistic clones (e.g., using SWAP gate). The CNOT gate, as described in further detail in connection with FIG. 6, may be a two-qubit quantum gate configured to perform a conditional operation where the state of one qubit (the target) is flipped if the other qubit (the control) is in a particular state (usually the state |1 [symbol] ). In quantum cloning, the CNOT gate may be used to generate approximate clones. The SWAP gate, as described in further detail in FIG. 7, may be configured to exchange the quantum states of two qubits. In quantum cloning, the SWAP gate may be used to transfer quantum states between a qubit and a target qubit probabilistically.

The output interface 312 may be the same or similar in configuration to the output interface 110 (shown in FIG. 1) and/or the output interface 216 (shown in FIG. 2). Specifically, the input interface 312 may be operatively coupled to the control unit 304 and configured to direct the original qubit and its clones toward their intended destination (e.g., the variable-strength measurement unit 108).

It is to be understood that the structure of the quantum cloning unit 106 and its components described herein represents merely one embodiment of a myriad of possible configurations. The structure of the quantum cloning unit 106 showcases a specific arrangement and interaction of quantum elements-including quantum gates, and control mechanisms-that collectively facilitate quantum cloning. However, this configuration is not limiting, and the structure of the quantum cloning unit 106 and its constituent components can vary to accommodate different quantum cloning and computing paradigms, physical implementations, and technological advancements. Consequently, while the present disclosure provides a comprehensive illustration of one potential quantum cloning unit, it is to be understood that this is an exemplification of broader principles of quantum computing and should not be construed as a limitation on the scope of the invention, which is capable of being implemented in various other forms, technologies, and configurations.

### Example Variable-Strength Measurement Unit

FIG. 4 illustrates an example variable-strength measurement unit 108, in accordance with an embodiment of the invention. As shown in FIG. 4, the variable-strength measurement unit 108 may include an input interface 402, a measurement unit 404, and an output interface 412. The measurement unit 404 may include a quantum memory 406, a QPU 408, and measurement operators 410.

The input interface 402 may be the same or similar in configuration to the input interface 102 (shown in FIG. 1), the input interface 202 (shown in FIG. 2), and/or the input interface 402 (shown in FIG. 3). Specifically, the input interface 402 may be operatively coupled to and configured to receive qubits from external quantum systems or from other components within the system environment (e.g., system environment 100), such as the quantum cloning unit 106 or the secondary quantum unit 218. In example embodiments, the input interface 402 may be configured to minimize any environmental interactions that could potentially disturb the quantum states of the qubits. This may include shielding against electromagnetic interferences, maintaining optimal temperature conditions, and employing vibration dampening techniques. The input interface 402 may align the qubits to the appropriate configuration required by the variable-strength measurement unit 404, ensuring that they are in the optimal state for precise measurement. This may include basic pre-measurement processing tasks such as quantum state verification, coherence checking, and synchronization with the measurement protocols of the variable-strength measurement unit 404.

The variable-strength measurement unit 404 may be operatively coupled to the input interface 402 and configured to execute minimally invasive (e.g., weak) measurements on the quantum states of the incoming qubits. As shown in FIG. 3, the measurement unit 404 may include a quantum memory 406, a QPU 408, and measurement operators 410. Quantum memory 406 may be same or similar to the quantum memory 306. Specifically, the quantum memory 406 may be configured to store the qubits (or quantum states) temporarily during the measurement process. The quantum memory 406 may allow for the retention and stabilization of quantum states before, during, and after measurements, facilitating repeated or continuous measurement processes.

The QPU 408 may be same or similar to the QPU 308 of FIG. 3 and configured to manage and control the measurement processes. Specifically, the QPU 308 may process the data obtained from the measurements and execute algorithms that determine how measurements should be conducted based on the state of the quantum system and the measurement goals (e.g., variable-strength based measurement). In this regard, the QPU 408 may adjust measurement parameters dynamically based on real-time data and feedback from the measurement operations.

The measurement operators 410 may include tools or mechanisms configured to physically interact with the qubits and/or their quantum states to extract information. In this regard, the measurement operators 410 may include specialized quantum sensors, photon detectors, or other quantum interaction devices designed to implement variable-strength measurement techniques on the qubit. In specific embodiments, the measurement operators 410 may include advanced optical components, quantum dot technologies, or nano-fabricated devices specifically designed for low-impact interaction with quantum systems. The measurement operators 410 may also include a variable strength setting. The variable strength setting may be configured to adjust the interaction strength between the measurement unit 404 and the quantum state (of the qubits) under observation. The adjustment capability allows for optimization of the balance between the amount of information derived from a measurement and the degree of disturbance inflicted upon the quantum state of the qubit being measured.

The output interface 412 may be the same or similar in configuration to the output interface 110 (shown in FIG. 1), the output interface 216 (shown in FIG. 2), and/or the output interface 412 (shown in FIG. 3). Specifically, the input interface 412 may be operatively coupled to the measurement unit 404 and configured to direct the measurement outcome to external systems or further processing stages.

It is to be understood that the structure of the variable-strength measurement unit 108 and its components as described herein represents merely one embodiment of a myriad of possible configurations. The structure of the variable-strength measurement unit 108 showcases a specific arrangement and interaction of quantum elements that collectively facilitates variable-strength measurement operations. However, this configuration is not limiting, and the structure of the variable-strength measurement unit 108 and its constituent components can vary to accommodate different variable-strength measurement paradigms, physical implementations, and technological advancements. Consequently, while the present disclosure provides a comprehensive illustration of one potential variable-strength measurement unit, it is to be understood that this is an exemplification of broader principles of quantum measurement and should not be construed as a limitation on the scope of the invention, which is capable of being implemented in various other forms, technologies, and configurations.

Furthermore, in the descriptions provided herein, it is recognized that various units within the system environment 100, such as the quantum cloning unit 106 and the variable-strength measurement unit 108, are depicted as potentially possessing dedicated resources, including but not limited to quantum memory, quantum processing units (QPUs), and other quantum computational elements. However, it is also contemplated that such resources may be shared between different units within the same system. The architecture of the system environment 100 may allow for the flexible allocation and sharing of resources such as quantum memories and QPUs. For example, a single quantum memory could serve both the quantum cloning unit 106 and the variable-strength measurement unit 108, wherein quantum states from both units are stored and managed within a unified memory system. Similarly, a centralized QPU might manage computational tasks and control protocols for multiple units, distributing its processing power as required to support various operations concurrently.

### Example Method for Quantum Information Retrieval Using Quantum Cloning and Variable-Strength Measurement

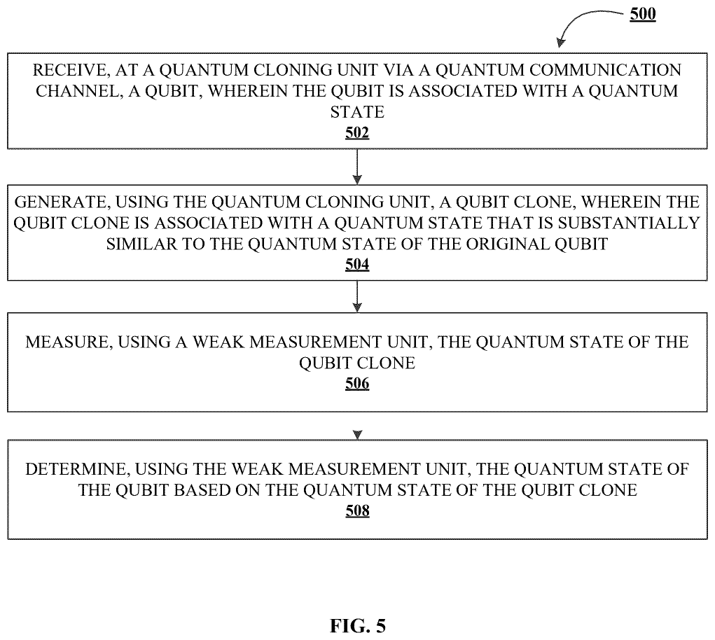

FIG. 5 illustrates an example method 500 for quantum information retrieval using quantum cloning and variable-strength measurement, in accordance with an embodiment of the invention. As shown in block 502, a qubit is received at a quantum cloning unit via a quantum communication channel. The qubit may be associated with a quantum state. As described herein, a qubit is the fundamental unit of quantum information, analogous to a bit in classical computing. The quantum state of the qubit may represent a complete description of the qubit's state at any given moment, encapsulating all the information necessary to describe the qubit's behavior in terms of probabilities and potential outcomes of measurements.

As shown in block 504, a qubit clone is generated using the quantum cloning unit. The qubit clone is associated with a quantum state that is substantially similar to the quantum state of the original qubit. As described herein, the quantum cloning unit (e.g., quantum cloning unit 106) may be configured to replicate quantum states of qubits. While the no-cloning theorem prohibits the creation of an identical copy of an arbitrary unknown quantum state, quantum mechanics permits the creation of approximate and/or probabilistic clones. Approximate cloning and probabilistic cloning do not contravene the no-cloning theorem because they do not yield perfect copies of the quantum states. Approximate cloning generates clones that closely resemble the original quantum state but with some degree of inaccuracy, while probabilistic cloning provides a higher fidelity clone but only succeeds a fraction of the time. As such, the quantum cloning unit may be configured to implement both approximate and probabilistic cloning methods to manage the trade-offs between cloning fidelity and success probability. In one example, the quantum cloning unit may be configured to use a controlled-NOT (CNOT) gate to produce an approximate clone of the qubit by deterministically replicating the quantum state to some degree (as described in more detail in connection with FIG. 6). In another example, the quantum cloning unit may be configured to use a SWAP gate to produce a probabilistic clone of the qubit by introducing a stochastic element in the cloning process (as described in more detail in connection with FIG. 7). Additionally or alternatively, the quantum cloning unit may be configured to use the CNOT and SWAP gates to produce probabilistic clones. It is to be understood that approximate and probabilistic cloning are illustrative examples and not exhaustive; other cloning methodologies may also be employed and are contemplated within the scope of this invention. For instance, state-dependent cloning, where the cloning strategy is tailored based on the specific characteristics of the quantum state being cloned, and phase-covariant cloning, which is optimized for cloning quantum states that are known to lie on a great circle of the Bloch sphere, are also possible and fall within the contemplated range of functionalities for the quantum cloning unit.

As shown in block 508, the quantum state of the qubit clone is measured using the variable-strength measurement unit. As described herein, the variable-strength measurement unit may operate on the principle of variable-strength measurement, a methodology that allows for obtaining partial information about a quantum state without causing its complete collapse, a common outcome with traditional strong measurements. Unlike strong measurements that significantly disrupt the quantum state (e.g., collapses the wavefunction to a particular eigenstate), variable-strength measurements gently interact with the quantum state, thereby preserving the state's coherence and entanglement properties to a large extent. As described herein, the variable-strength measurement unit may be a variable-strength quantum measurement unit that allows for the adjustment of the interaction strength between the measurement apparatus and the quantum system being observed for optimizing the trade-offs between the information obtained from a measurement and the disturbance introduced to the system's quantum state.

As shown in block 510, the quantum state of the qubit is determined by the variable-strength measurement unit based on the quantum state of the qubit clone. As described herein, the output of the quantum cloning unit is a qubit clone that carries a quantum state substantially similar to that of the original qubit. When both the original qubit and its clone are available, the variable-strength measurement unit (e.g., variable-strength measurement unit 108) can perform simultaneous or sequential measurements on both. This dual measurement setup increases the amount of information gathered about the quantum state without collapsing either the original or the cloned qubit's state. By measuring both, the variable-strength measurement unit can leverage the redundancy and correlation between the original qubit and the qubit clone to refine the accuracy of the quantum state estimation. Because variable-strength measurements only impart minimal disturbance, measuring both the qubit and its clone may provide multiple, slightly varying snapshots of the same underlying quantum state. This redundancy may aid in averaging out the noise and other measurement errors, leading to a more precise and reliable estimate of the quantum state. Furthermore, by cloning the qubit and using variable-strength measurements, the impact of the wavefunction collapse may be minimized.

### Example Method for Quantum Cloning Using a CNOT Gate

FIG. 6 illustrates an example method 600 for quantum cloning using a CNOT gate, in accordance with an embodiment of the invention. As described herein, approximate cloning in quantum mechanics may refer to the process of creating a copy of a quantum state that is close but not identical to the original. This type of cloning does not violate the no-cloning theorem. Approximate cloning may be advantageous in quantum applications where exact replication is neither possible nor necessary, but where it is beneficial to have a replica that retains much of the informational content of the original quantum state of the original qubit. The CNOT gate, a fundamental quantum logic gate, may serve as an effective tool for approximate cloning within the constraints set by quantum mechanics.

As shown in block 602, the qubit is received at the quantum cloning unit. As described herein, the qubit, associated with a specific quantum state, serves as the original qubit intended for cloning.

As shown in block 604, a secondary qubit is initialized. In the cloning process, initializing a secondary qubit prepares the secondary qubit to receive and replicate the quantum state of the original qubit. This initialization involves setting the secondary qubit to a specific, well-defined quantum state (e.g., initial quantum state) prior to any cloning operations. For example, this initial quantum state may be the ground state, denoted as |0 [symbol] , which provides a clean and predictable starting point for the cloning process. The purpose of initializing the secondary qubit in such a state is to ensure that any subsequent quantum operations, such as the application of the CNOT gate, can be precisely controlled and the outcomes can be accurately predicted.

As shown in block 606, the CNOT gate is implemented on the qubit and the secondary qubit. The CNOT gate is a two-qubit quantum logic gate operating under the following rule: the state of the target qubit (e.g., the secondary qubit) is flipped from |0 [symbol] to |1 [symbol] or vice versa if the control qubit (e.g., the original qubit) is in the |1 [symbol] state. If the control qubit is in the |0 [symbol] state, the state of the target qubit remains unchanged. The original qubit, which carries the quantum state to be cloned, is designated as the control qubit. The secondary qubit, initialized to a standard state such as |0 [symbol] , is designated as the target qubit.

As shown in block 608, the quantum state of the qubit is transferred to the secondary qubit. In other words, the initial quantum state of the secondary qubit is replaced with the quantum state of the qubit to generate the qubit clone. The entangling process involves using the CNOT gate to interlink the quantum states of the original qubit and the secondary qubit to produce an approximate clone. In an example embodiment, the quantum cloning operation may be governed by the equation ρ′=ϵ·CNOT·ρ·CNOT+(1−ϵ)·ρ, where ρ′ may represent the quantum state of the qubit clone and ρ may indicate the quantum state of the original qubit. Here, 0≤ϵ≤1 may be a probability parameter received by the system, dictating the level of similarity required between the qubit and its clone. The probability parameter may be used to influence the extent to which the CNOT gate is utilized to modify the secondary qubit's state.

The action of the CNOT gate, under the influence of ϵ, effectively mixes the original state ρ with its transformed state through the CNOT operation, resulting in a secondary qubit whose quantum state may be a weighted combination of the unaltered state and the state transformed by the CNOT operation. This allows for adjustable fidelity in the cloning process, where the degree of similarity between the original and the clone can be finely controlled by adjusting ϵ. Consequently, the secondary qubit does not emerge as a perfect copy but as an approximate clone whose fidelity (the degree to which it replicates the original) can be precisely tuned based on the parameter e and the specifics of the entanglement process.

### Example Method for Quantum Cloning Using a SWAP Gate

FIG. 7 illustrates an example method 700 for quantum cloning using a SWAP gate, in accordance with an embodiment of the invention. As described herein, probabilistic cloning may provide a high-fidelity clone of a quantum state of a qubit with the caveat that the cloning process succeeds only a fraction of the time. This approach acknowledges the fundamental limitations imposed by the no-cloning theorem but navigates these limits by allowing for a probability that the cloning attempt may fail.

As shown in block 702, a target bit with an initial quantum state is initialized. The initialization phase in the probabilistic cloning process using the SWAP gate may include preparing the target qubit in a specific, well-defined initial quantum state before any cloning operations occur. For instance, the initial quantum state may be a ground state, denoted as |0 [symbol] . The preparation of the target qubit in the ground state |0 [symbol] may establish a predictable starting condition for the cloning operation. By starting from a known quantum state (e.g., the initial quantum state), the process can be controlled with greater precision, as the effects of the subsequent quantum operations are predictable and quantifiable based on the initial quantum state.

As shown in block 704, an identity operation is executed on the qubit to maintain coherence of the quantum state of the qubit. Here, the identity operation may be associated with a probability, p. The primary function of the identity operation is to preserve the coherence of the qubit's quantum state. Coherence may refer to the qubit maintaining its quantum properties, such as superposition and entanglement, over time. The identity operation essentially does nothing to the qubit, leaving it unchanged; it is used here to maintain the integrity of the quantum state of the qubit and reduce the likelihood of decoherence. The identity operation is applied with a probability p, which is a pre-determined parameter of the cloning process. The choice of p may balance the need to maintain quantum coherence against the need to execute the cloning operation.

As shown in block 706, a SWAP operation is implemented between the qubit and the target qubit to transfer a portion of the quantum state of the qubit to the target qubit to generate the qubit clone. Here, the SWAP operation may be associated with a probability, (1−p), indicating the likelihood that the SWAP will actually be performed during a given operation cycle. Additionally, the system may receive a specific weight that determines the exact portion of the quantum state to be transferred from the original qubit to the target qubit. This weight may control the extent to which the quantum state is shared between the original and the target qubit, enabling fine-tuning of the cloning process to achieve desired outcomes in terms of fidelity and quantum state integrity. The SWAP operation enables the creation of the qubit clone.

In specific embodiments, the identity operation and the SWAP operation may be executed concurrently on the qubit and the target qubit. The identity operation, associated with a probability p, may be used to maintain the coherence of the qubit's quantum state by preserving its quantum properties, such as superposition and entanglement, over time. Concurrently, the SWAP operation, associated with a probability (1−p), may transfer a portion of the quantum state of the qubit to the target qubit to generate the qubit clone. The specific weight received by the system may determine the exact portion of the quantum state to be transferred, allowing for fine-tuning of the cloning process to achieve desired outcomes in terms of fidelity and quantum state integrity. By performing these operations simultaneously, the integrity of the original quantum state may be maintained while enabling the creation of the qubit clone.

The SWAP gate is designed to exchange the quantum states of two qubits. For two qubits in states |Ψ [symbol] and |ϕ [symbol] , respectively, applying the SWAP gate results in the first qubit taking the state |ϕ [symbol] and the second qubit taking the state |Ψ [symbol] . The SWAP operation transfers the quantum state from the original qubit to the target qubit in the cloning process. Although the SWAP operation ideally results in a complete exchange of states, in the context of probabilistic cloning, it is characterized by the fact that it does not always occur. Instead, its execution is contingent on a probability 1−p. This means that there is a 1−p chance that the SWAP operation will be performed during any given implementation cycle, transferring the quantum state from the original to the target qubit. The probability 1−p may represent the likelihood that the SWAP operation will occur, contrasting with the probability p that the identity operation will take place. This probabilistic approach allows for the preservation of the original qubit's quantum state during times when the SWAP is not executed, maintaining the quantum coherence and integrity of the system. The choice of p and consequently 1−p may be strategically made based on the desired balance between cloning fidelity and the maintenance of the original state's coherence. A higher p means more frequent identity operations, preserving the original state but reducing the frequency of cloning attempts.

When the SWAP operation occurs, the target qubit inherits the quantum state of the original qubit, effectively becoming its clone. This cloned qubit now possesses a quantum state that closely resembles that of the original, albeit with the understanding that the process only succeeds probabilistically. By employing the SWAP gate in this probabilistic manner, the quantum cloning process effectively manipulates quantum information to produce clones under controlled conditions, aiming to maximize clone fidelity while minimizing disturbances to the quantum state of the original qubit.

### Example Method for Quantum Information Retrieval Using Photon Number Splitting (PNS) and Variable-Strength Measurement

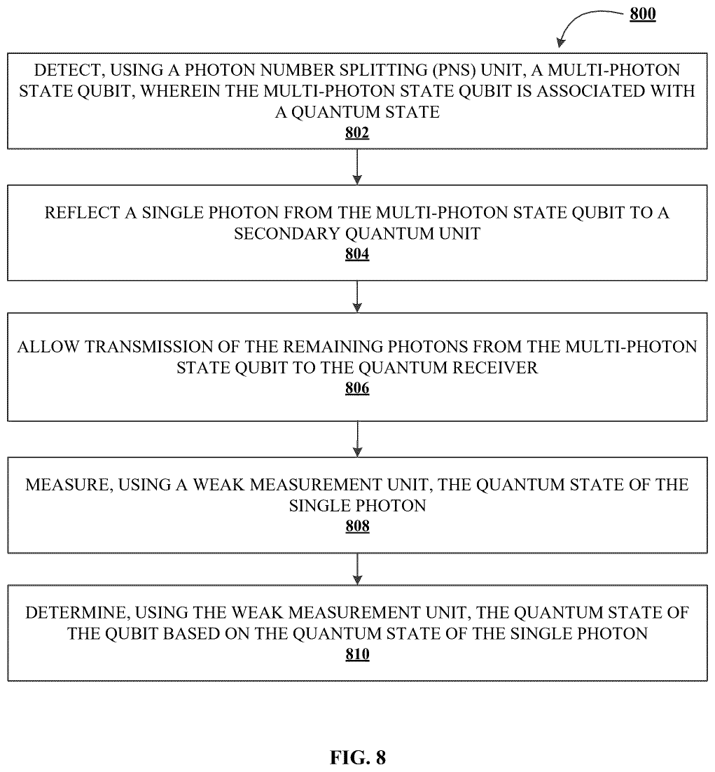

FIG. 8 illustrates an example method 800 for quantum information retrieval using photon number splitting and variable-strength measurement, in accordance with an embodiment of the invention. As shown in block 802, the qubit is determined to be a multi-photon state qubit using the PNS unit (e.g., PNS unit 104). A multi-photon state qubit may refer to a qubit that is encoded across multiple photons, rather than being confined to the quantum state of a single photon. In a multi-photon state qubit, the quantum information or the binary state |0 [symbol] or |1 [symbol] is distributed across several photons. This distribution can arise due to the physical generation of the pulse, where a single pulse may inadvertently include multiple photons due to the statistical nature of the photon generation process. As described herein, a PNS unit may be a specialized device used in quantum communication systems to exploit vulnerabilities in systems employing weak coherent pulses, which can contain multiple photons per qubit. The primary function of a PNS unit is to identify and manipulate multi-photon pulses, enabling the interception and analysis of quantum information without detection by the legitimate parties involved in the communication.

As shown in block 804, a single photon from the multi-photon state qubit is reflected to a secondary quantum unit. Once a suitable multi-photon state qubit is detected, the PNS unit may be configured to isolate and reflect one photon from the qubit. This isolated photon is then directed toward a secondary quantum unit (e.g., secondary quantum unit 218). The secondary quantum unit may be a separate module designed to store, measure, or further process the reflected photon. The secondary quantum unit may be configured to handle the reflected photon in a way that preserves its quantum state for subsequent analysis.

As shown in block 806, the remaining photons from the multi-photon state qubit are allowed for transmission to a quantum receiver. The remaining photons in the multi-photon state qubit may be allowed to continue their journey to the intended receiver. This part of the operation is essential for the cavesdropping to remain undetected, as any significant disturbance to the qubit could alert the parties to the interception attempt.

In an example embodiment, a single photon Raman interaction (SPRINT) unit, characterized by its ability to manage photon interactions based on Raman scattering principles, serves as an effective tool for implementing photon number splitting (PNS) functions. In an initial state, the SPRINT unit may be configured at a first energy state, optimized to detect the incidence of multi-photon state qubits emitted from a quantum transmitter. This first energy state may be specifically tuned to be sensitive to the incoming photons' characteristics. Upon detecting a multi-photon state qubit, the SPRINT unit may trigger a change in its energy state. In this second energy state, the SPRINT unit may reflect a single photon from the multi-photon pulse. Post-reflection, the SPRINT unit in its second energy state may be configured to allow the transmission of the remaining photons in the multi-photon state qubit towards the intended quantum receiver.

As shown in block 808, the quantum state of the single photon is measured using the variable-strength measurement unit. As described herein, the variable-strength measurement unit may operate on the principle of variable-strength measurement, a methodology that allows for obtaining partial information about a quantum state without causing its complete collapse, a common outcome with traditional strong measurements. Unlike strong measurements that significantly disrupt the quantum state (e.g., collapses the wavefunction to a particular eigenstate), variable-strength measurements gently interact with the single photon, thereby preserving the quantum state's coherence and entanglement properties to a large extent.

As shown in block 810, the quantum state of the qubit is determined by the variable-strength measurement unit based on the quantum state of the single photon. As described herein, the output of the PNS unit is a single reflected photon that carries information associated with the quantum state of the original qubit (e.g., the multi-photon state qubit) transmitted by the quantum transmitter. The variable-strength measurement unit may measure the quantum state of the single photon and then determine the quantum state of the qubit based on the measurement outcome (and potentially also based on some amount of prior knowledge).

In example embodiments, quantum cloning, PNS, and variable-strength measurement, when integrated, may leverage the unique properties of quantum mechanics to maximize the accuracy and security of quantum communication systems. Quantum cloning, typically prohibited from creating perfect copies by the no-cloning theorem, can be applied to quantum states intercepted via PNS. In a scenario where a PNS unit, such as a SPRINT unit, may detect and isolate a multi-photon state qubit, the PNS unit can reflect a single photon from the multi-photon state qubit while allowing the remainder to continue to their intended destination. This single photon, carrying information associated with the quantum state of the multi-photon state qubit may be directed to a quantum cloning unit. Here, the single reflected photon undergoes a cloning process, where either approximate or probabilistic cloning techniques may be employed to create a clone of the quantum state associated with the photon. The quantum cloning process may generate a qubit clone that mirrors the state of the original intercepted photon, which in turn provides information associated with the quantum state of the multi-photon qubit, thus doubling the available data from a single interception event. The use of a CNOT gate or a SWAP gate within the cloning unit can facilitate this process, depending on whether deterministic or stochastic replication is desired. In specific embodiments, both the CNOT gate and the SWAP gate may be probabilistic, i.e., convexly mixed with the identity operation).

The dual measurement of both the original photon and its clone via variable-strength measurement significantly enhances the reliability of the quantum state estimation. By measuring both, the variable-strength measurement unit can leverage the redundancy and correlation between the single photon and its clone. This approach provides multiple, slightly varied snapshots of the same underlying quantum state, helping to average out noise and measurement errors. Consequently, this method leads to a more precise and reliable estimate of the quantum state, enhancing the overall efficacy of quantum information retrieval.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for quantum information retrieval, the system comprising:
a quantum cloning unit operatively coupled to a quantum communication channel and configured to:
receive, via the quantum communication channel, a qubit, wherein the qubit is associated with a quantum state;
generate a qubit clone, wherein the qubit clone is associated with a quantum state that is substantially similar to the quantum state of the qubit; and
a variable-strength measurement unit operatively coupled to the quantum cloning unit and configured to:
measure the quantum state of the qubit clone; and
determine the quantum state of the qubit based on the measurement of the quantum state of the qubit clone.

2. The system of claim 1, wherein the variable-strength measurement unit is configured to:
measure the quantum state of the qubit; and
determine the quantum state of the qubit based on the measurement of the quantum state of the qubit clone and the measurement of the quantum state of the qubit.

3. The system of claim 1, further comprising:
a photon number splitting (PNS) unit operatively coupled to the quantum communication channel and configured to:
determine that the qubit is a multi-photon state qubit;
reflect a single photon from the multi-photon state qubit to a secondary quantum unit; and
allow transmission of the remaining photons from the multi-photon state qubit to the quantum receiver.

4. The system of claim 3, wherein the PNS unit is configured to:
store the single photon in a quantum memory associated with the secondary quantum unit.

5. The system of claim 3, wherein the variable-strength measurement unit is operatively coupled to the PNS unit, and wherein the variable-strength measurement unit is configured to:
measure a quantum state of the single photon; and
determine the quantum state of the qubit based on the quantum state of the single photon.

6. The system of claim 3, wherein the PNS unit is a single photon Raman interaction (SPRINT) unit, configured to:
detect, in a first energy state, an incidence of the multi-photon state qubit, wherein the incidence of the multi-photon state qubit triggers a change in energy state from the first energy state to a second energy state resulting in a reflection of the single photon; and
allow, in the second energy state, transmission of the remaining photons from the multi-photon state qubit to the quantum receiver.

7. The system of claim 1, wherein the quantum cloning unit is configured to generate the qubit clone using a controlled-NOT (CNOT) gate, wherein the quantum cloning unit is further configured to:
receive the qubit;
initialize a secondary qubit, wherein the secondary qubit is associated with an initial quantum state;
implement the CNOT gate on the qubit and the secondary qubit; and
entangle, using the CNOT gate, the qubit and the secondary qubit to replace the initial quantum state of the secondary qubit with the quantum state of the qubit to generate the qubit clone.

8. The system of claim 7, wherein the quantum cloning unit is configured to:
receive a probability e indicating a required similarity between the qubit and the qubit clone; and
generate the qubit clone using the following equation: ρ′=ϵ·CNOT·ρ·CNOT+(1−ϵ)·ρ, wherein ρ′ indicates the quantum state of the qubit clone, and wherein ρ indicates the quantum state of the qubit.

9. The system of claim 1, wherein the quantum cloning unit is configured to generate the qubit clone using a SWAP gate, and wherein the quantum cloning unit is further configured to:
initialize a target qubit, wherein the target qubit is associated with an initial quantum state;
execute an identity operation on the qubit to maintain coherence of the quantum state of the qubit, wherein the identity operation is associated with a probability, p; and
implement, using the SWAP gate, a SWAP operation between the qubit and the target qubit to transfer a portion of the quantum state of the qubit to the target qubit to generate the qubit clone, wherein the SWAP operation is associated with a probability, (1−p).

10. The system of claim 9, wherein the quantum cloning unit is configured to:
receive a weight associated with the transfer of the portion of the quantum state; and
determine the portion of the quantum state to be transferred from the qubit to the target qubit based on at least the received weight.

11. A system for quantum information retrieval, the system comprising:
a photon number splitting (PNS) unit operatively coupled to a quantum communication channel and configured to:
detect a multi-photon state qubit, wherein the multi-photon state qubit is associated with a quantum state;
reflect a single photon from the multi-photon state qubit to a secondary quantum unit; and
allow transmission of the remaining photons from the multi-photon state qubit to the quantum receiver; and
a variable-strength measurement unit operatively coupled to the PNS unit and configured to:
measure a quantum state of the single photon; and
determine the quantum state of the qubit based on the quantum state of the single photon.

12. The system of claim 11, wherein the PNS unit is configured to:
store the single photon in a quantum memory associated with the secondary quantum unit.

13. The system of claim 11, wherein the PNS unit is a single photon Raman interaction (SPRINT) unit, configured to:
detect, in a first energy state, an incidence of the multi-photon state qubit, wherein the incidence of the multi-photon state qubit triggers a change in energy state from the first energy state to a second energy state resulting in a reflection of the single photon; and
allow, in the second energy state, transmission of the remaining photons from the multi-photon state qubit to the quantum receiver.

14. The system of claim 11, further comprising:
a quantum cloning unit operatively coupled to the quantum communication channel and configured to generate a qubit clone, wherein the qubit clone is associated with a quantum state that is substantially similar to the quantum state of the single photon.

15. A method for quantum information retrieval, the method comprising:
receiving, at a quantum cloning unit via a quantum communication channel, a qubit, wherein the qubit is associated with a quantum state;
generating, using the quantum cloning unit, a qubit clone, wherein the qubit clone is associated with a quantum state that is substantially similar to the quantum state of the qubit; and
measuring using a variable-strength measurement unit, the quantum state of the qubit clone; and
determining, using the variable-strength measurement unit, the quantum state of the qubit based on the quantum state of the qubit clone.

16. The method of claim 15, wherein determining the quantum state of the qubit further comprises:
measuring the quantum state of the qubit; and
determining the quantum state of the qubit based on the measurement of the quantum state of the qubit clone and the measurement of the quantum state of the qubit.

17. The method of claim 15, wherein the method further comprises:
determining, using a photon number splitting (PNS) unit, that the qubit is a multi-photon state qubit;
reflecting, using the PNS unit, a single photon from the multi-photon state qubit to a secondary quantum unit; and
allowing, using the PNS unit, transmission of the remaining photons from the multi-photon state qubit to the quantum receiver.

18. The method of claim 17, wherein the PNS unit is a single photon Raman interaction (SPRINT) unit, wherein the method further comprises:
detecting, using the SPRINT unit in a first energy state, an incidence of the multi-photon state qubit from the quantum transmitter, wherein the incidence of the multi-photon state qubit triggers a change in energy state from the first energy state to a second energy state resulting in a reflection of the single photon; and
allowing, using the SPRINT unit in the second energy state, transmission of the remaining photons from the multi-photon state qubit to the quantum receiver.

19. The method of claim 15, wherein the qubit clone is generated using a controlled-NOT (CNOT) gate, wherein generating the qubit clone further comprises:
receiving the qubit;
initializing a secondary qubit, wherein the secondary qubit is associated with an initial quantum state;
implementing the CNOT gate on the qubit and the secondary qubit; and
entangling, using the CNOT gate, the qubit and the secondary qubit to replace the initial quantum state of the secondary qubit with the quantum state of the qubit to generate the qubit clone.

20. The method of claim 15, wherein the qubit clone is generated using a SWAP gate, wherein generating the qubit clone further comprises:
initializing a target qubit, wherein the target qubit is associated with an initial quantum state;
executing an identity operation on the qubit to maintain coherence of the quantum state of the qubit, wherein the identity operation is associated with a probability, p; and
implementing, using the SWAP gate, a SWAP operation between the qubit and the target qubit to transfer a portion of the quantum state of the qubit to the target qubit to generate the qubit clone, wherein the SWAP operation is associated with a probability, (1−p).

21. A method for quantum information retrieval, wherein the method comprises:
detecting, using a photon number splitting (PNS) unit, a multi-photon state qubit, wherein the multi-photon state qubit is associated with a quantum state;
reflecting a single photon from the multi-photon state qubit to a secondary quantum unit; and
allowing transmission of the remaining photons from the multi-photon state qubit to the quantum receiver; and
measuring, using a variable-strength measurement unit, a quantum state of the single photon; and
determining, using the variable-strength measurement unit, the quantum state of the qubit based on the quantum state of the single photon.

22. The method of claim 21, wherein the method further comprises:
generating, using a quantum cloning unit, a qubit clone, wherein the qubit clone has a quantum state that is substantially similar to the quantum state of the single photon.
